(19) United States
(12) Patent Application Publication
(10) Pub. No.: US 2003/0061176 A1
(43) Pub. Date: Mar. 27, 2003

(54) E-mail add-on service

(76) Inventor: Colleen A. Hoar, Fairfax Station, VA (US)

Correspondence Address: WEISS & MOY PC, 4204 NORTH BROWN AVENUE, SCOTTSDALE, AZ, 85251, US

(21) Appl. No.: 10/155,733

(22) Filed: May 28, 2002

Related U.S. Application Data
(60) Provisional application No. 60/293,171, filed on May 25, 2001.

(51) Int. Cl. G06F 17/60

(52) U.S. Cl. 705/402; 705/1

(57) ABSTRACT

An e-mail add-on service provides electronic notification regarding delivery status of a mailed item. In one embodiment, a sender of a mailed item receives electronic notification that a mailed item has been received by a recipient. In another, an intended recipient of a mailed item receives notification that a mailed item has been sent. Optionally, tracking of a mailed item through the mailstream may also be provided electronically to a sender and/or a recipient. Personal messages may be provided as part of such electronic notification.

### RELATED APPLICATIONS

This non-provisional application claims priority from provisional application No. 60/293,171, filed on May 25, 2001.

### BACKGROUND OF THE INVENTION

1. Field of Invention

This invention relates generally to mail-related services, including delivery notification and, more specifically, to a method and system that provides electronic notification to a sender and/or recipient regarding delivery of a mail item.

2. Description of the Related Art

Many customers send items through the mail using a mailer, such as the United States Postal Service (USPS). In the past, to determine if and when a mailed item reached its intended recipient, the sender could contact the recipient using, for example, the telephone. The sender could also request that the mailer send a notification, such as a return receipt or certificate of delivery, to the sender through the mail. The notification might state when the item was delivered and what individual received the item. These conventional options for delivery notification could only be delivered as quickly as the mail, usually taking several days to reach the sender.

Systems and methods consistent with the present invention provide delivery notification and other mail-related services much more quickly. In one implementation, an electronic notification is used, such as an e-mail message, which can be sent to the sender as soon as the item is delivered to the recipient. Using the internet, or other network, the electronic notification is delivered within a few minutes of its delivery. Systems and methods consistent with the present invention also can provide notification to the recipient, for example, to alert the recipient that an item is en route, so the recipient can know when to expect delivery.

### SUMMARY OF THE INVENTION

It is an object of the present invention to provide electronic notification regarding mail delivery to a sender and/or recipient.

It is a further object of the present invention to provide electronic notification regarding mail delivery within a few minutes of delivery of a mailed item.

It is a still further object of the present invention to provide electronic notification to a recipient of a mailed item that the mailed item is en route.

It is yet a further object of the present invention to provide electronic notification regarding mail delivery to a sender and/or a recipient, and to include with such notification a text message from one party to the other.

The foregoing and other objects, features, and advantages of the invention will be apparent from the following, more particular, description of the preferred embodiments of the invention, as illustrated in the accompanying drawings.

### BRIEF DESCRIPTION OF THE PREFERRED EMBODIMENTS

In accordance with one embodiment of the present invention, a method for providing delivery information regarding a mailpiece that is being delivered from a sender to a recipient is disclosed. The method comprising the steps of: receiving a service request at a service system from the sender regarding the mailpiece; receiving an electronic address at the service system from the sender; storing a tracking code with the service request at the service system; providing the tracking code by the service system to the sender for marking the mailpiece; determining tracking data corresponding to the tracking code at the service system, wherein the tracking data indicates a delivery status of the mailpiece; and sending the tracking data to the electronic address provided by the sender.

In accordance with another embodiment of the present invention, a method for providing delivery information regarding a mailpiece that is being delivered from a sender to a recipient is disclosed. The method comprises the steps of: receiving a service request at a service system from the sender regarding the mailpiece; wherein the service system includes a database, a set of allocated codes, originating and destinating delivery standards, and proper address formatting software; receiving an electronic address at the service system from the sender; storing a tracking code with the service request at the service system; providing the tracking code by the service system to the sender for marking the mailpiece; the service system generating a printable label for the mailpiece; wherein the printable label includes the tracking code, the recipient's physical address, and the sender's physical address; sending the printable label to the sender; determining tracking data corresponding to the tracking code at the service system, wherein the tracking data indicates a delivery status of the mailpiece; and sending the tracking data to the electronic address provided by the sender.

In accordance with yet another embodiment of the present invention, a delivery information system for mailpieces is disclosed. The system comprises, in combination: a service system; a mailpiece; a database adapted to store records for requests for service from the service system relating to delivery of the mailpiece and records of confirmation of the service; allocated codes to track the mailpiece through a mailstream; an electronic address for one of a sender and a recipient of the mailpiece; and a network permitting the sending of an electronic message regarding delivery status of the mailpiece from the service system to the electronic address.

### BRIEF DESCRIPTION OF THE DRAWINGS

FIG. 1A is a diagram illustrating the component portions of an embodiment of the e-mail add-on service of the present invention.

FIG. 1B is a diagram illustrating the component portions of another embodiment of the e-mail add-on service of the present invention.

FIG. 2A is a block diagram of an embodiment of an e-mail add-on service consistent with the present invention.

FIG. 2B is a block diagram of another embodiment of an e-mail add-on service consistent with the present invention.

FIG. 3A is a block diagram of a database component of an e-mail add-on service consistent with the present invention.

FIG. 3B is a more detailed block diagram of a database component of an e-mail add-on service consistent with the present invention.

FIG. 4A depicts a sample mailing label consistent with the present invention.

FIG. 4B depicts an alternative sample mailing label consistent with the present invention.

FIG. 5 is a block diagram of a system for tracking a mailpiece through the mailstream consistent with the present invention.

FIG. 6 is an example of one embodiment of PLANET code tracking data.

FIG. 7 is a flowchart of a process for providing one set of services in an e-mail add-on service consistent with the present invention where a PLANET code is used.

### DETAILED DESCRIPTION OF THE PREFERRED EMBODIMENTS

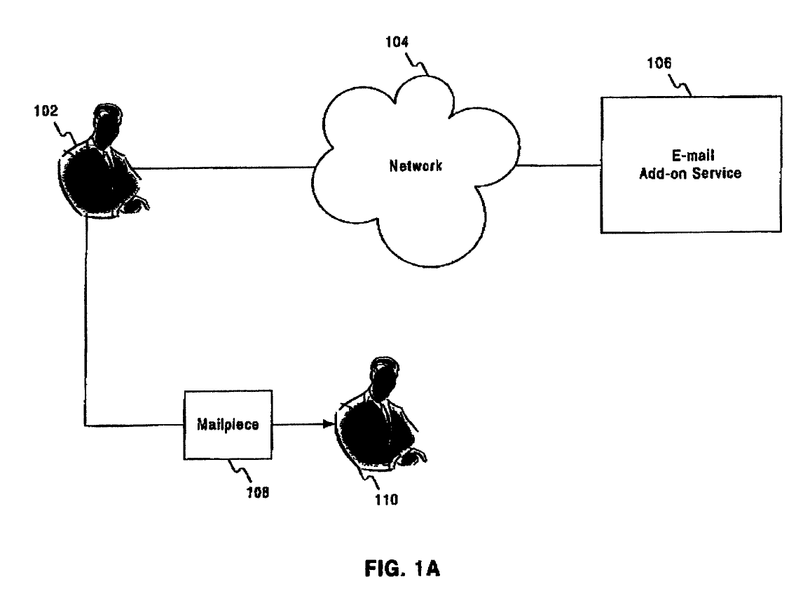

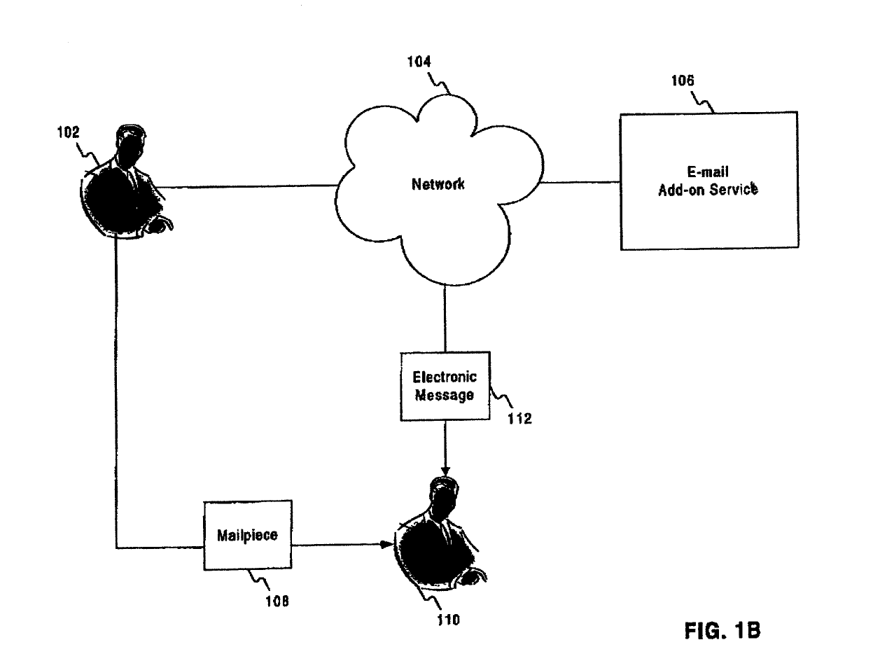

As shown in FIG. 1A, a sender 102 sends a mailpiece 108 to a recipient 110. Mailpiece 108 can be, for example, a letter or a package sent through the U.S. mail. Sender 102 can use a computer to communicate with a service system, referred to herein as an E-mail Add-on Service 106, via a network 104. Network 104 can be, for example, the internet. E-mail Add-on Service 106 can be provided, for example, by the mailer (not shown) responsible for delivering mailpiece 108 to recipient 110. Sender 102 can request a variety of services from E-mail Add-on Service 106. For example, sender 102 can request that a message be sent to recipient 110 to notify him when mailpiece 108 will be delivered. Sender 102 can also request that a message be sent to sender 102 to notify him when mailpiece 108 reaches a certain point in the mailstream, such as the recipient's local Post Office. If sender 102 desires confirmation receipt, sender 102 can also request that a message be sent to sender 102 to notify him when mailpiece 108 reaches recipient 110.

As FIG. 1B illustrates, an electronic message 112, such as an e-mail message, can be sent from E-mail Add-on Service 106 to recipient 110 via network 104. Electronic message 112 may include, for example, a personalized message provided by sender 102 and an expected date of delivery for mailpiece 108. Alternatively, an electronic message can be sent to sender 102 or to both sender 102 and recipient 110.

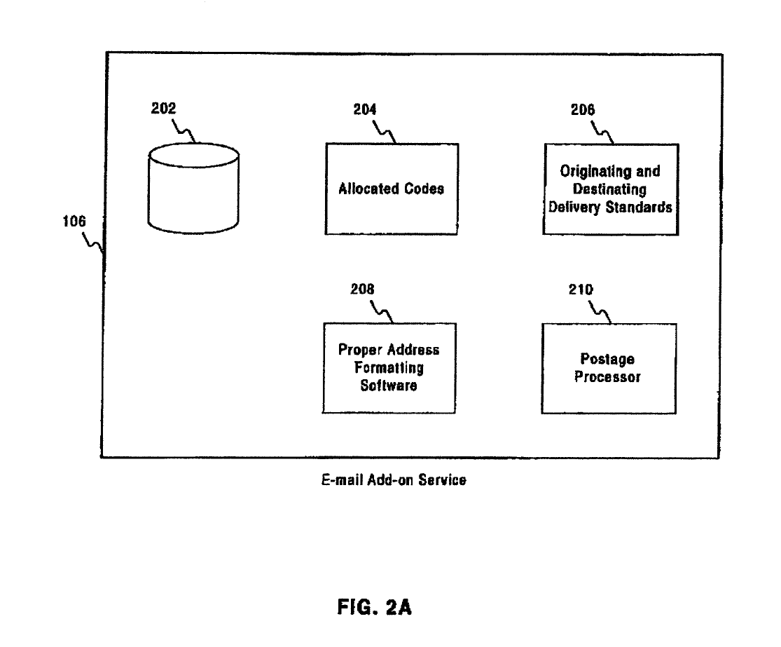

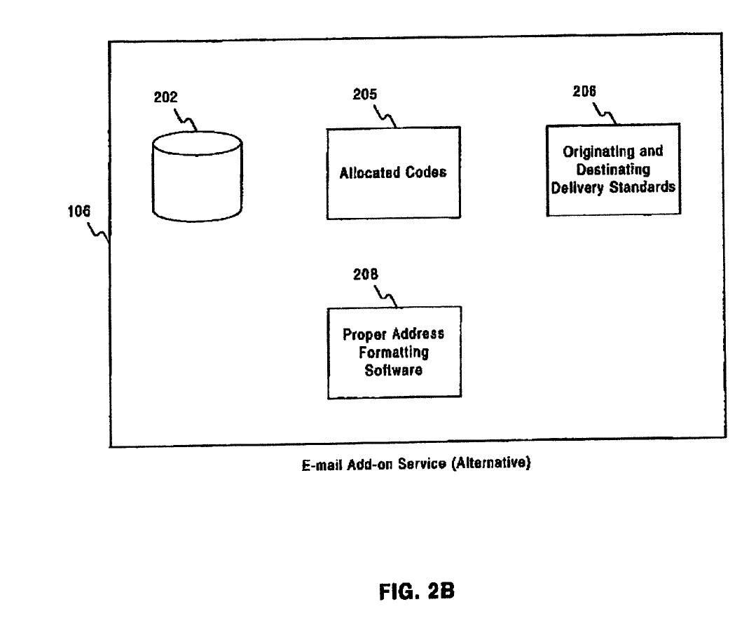

FIG. 2A is a block diagram of one embodiment of E-mail Add-on Service 106 consistent with the present invention. E-mail Add-on Service 106 can include a database 202, a set of allocated codes 204, originating and destinating delivery standards 206, proper address formatting software 208, and a postage processor 210. Allocated codes 204 are codes used to track mailpieces through a mailstream. For example, allocated codes 204 can be bar codes that are applied to a mailpiece, such as a PLANET code. The PLANET code is scanned by mail processing machines throughout the mailstream and the data is stored by a PLANET code system to track the location of the mailpiece at each stage of the delivery process. Originating and destinating delivery standards 206 can be used to estimate when a mailpiece will be delivered based on data such as the origination and destination locations. Proper address formatting software 208 can be used to standardize a given address to expedite the delivery process. Postage processor 210 can be used to calculate and print postage to be applied to a mailpiece.

FIG. 2B is a block diagram of another embodiment of E-mail Add-on Service 106 consistent with the present invention. In this embodiment, the allocated codes are PLANET codes, and postage is not included as part of E-Mail Add-on Service 106. One skilled in the art would recognize that a variety of variations could be used for E-mail Add-on Service 106.

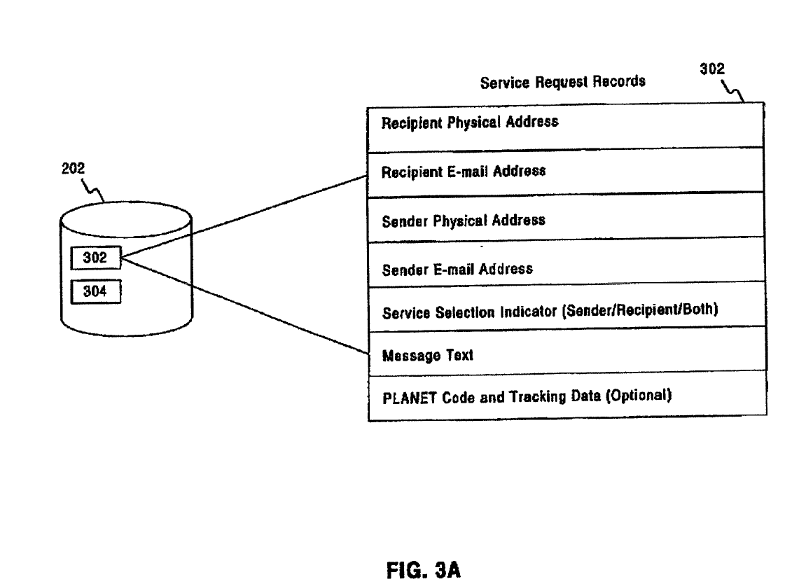

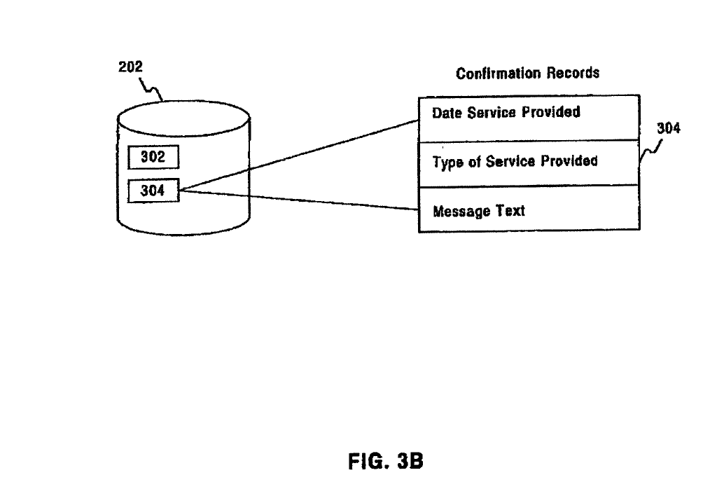

FIG. 3A is a block diagram of database 202 in greater detail. Database 202 can store records such as service request records 302 and confirmation records 304. When sender 102 contacts E-mail Add-on Service 106 via network 104, the information provided by sender 102 is stored in a service request record 302. Service request record 302 can include: recipient's physical address, recipient's e-mail address, sender's physical address, sender's e-mail address, a service selection indicator, message text. If a PLANET code is used, service request record 302 may also include PLANET code and tracking data.

The recipient's physical address is the address where mailpiece 108 is sent to, and the recipient's e-mail address is the electronic address where an electronic message 112 can be sent. The sender's physical address is the address where mailpiece 108 is sent from and the sender's e-mail address is the electronic address where an electronic message 112 can be sent. The service selection indicator enables sender 102 to request that an electronic message be sent to the sender, the recipient, or both. The message text is any personalized greeting or text provide by sender 102. This can be, for example, “Happy Birthday, Recipient. Your present is on the way.” If available, PLANET code and tracking data stores information about where mailpiece 108 is in the mailstream.

FIG. 3B is another block diagram of database 202 in greater detail. Database 202 can store records such as service request records 302 and confirmation records 304. When electronic message 112 is sent (either to the sender, the recipient, or both), a confirmation record 304 is created. Confirmation record 304 can include: the date service was provided, the type of service provided, and message text. The date service was provided can be, for example, the date that electronic message 112 was sent. The type of service provided can be, for example, sender notified, recipient notified, or both notified. The message text can be the text of electronic message 112. The data from confirmation record 304 can be provided to sender 102 to confirm that the service was provided successfully. Confirmation records 304 can also be used by E-mail Add-on Service 106 to track service efficiency or effectiveness.

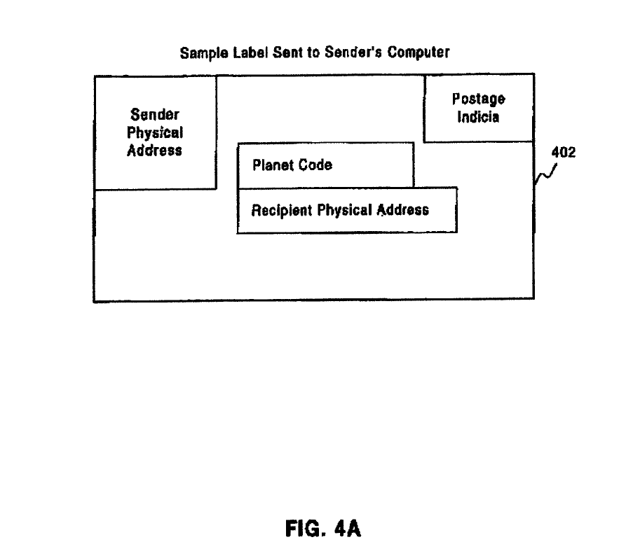

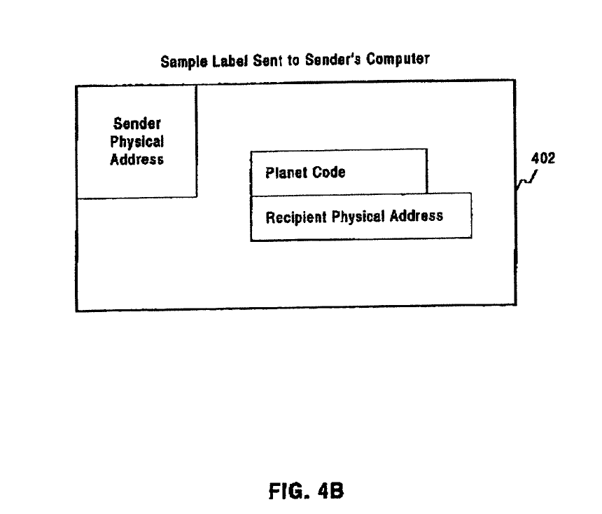

FIG. 4A depicts a sample mailing label consistent with the present invention. After sender 102 submits information to E-mail Add-On Service 106, a service request record 302 is created, as shown in FIG. 3A. Using the data in service request record 302, E-mail Add-on Service 106 can generate a printable label for mailpiece 108 and send it to sender 102's computer. In one implementation, label 402 can include a PLANET code, the recipient's physical address, the sender's physical address, and postage indicia. The PLANET code can be assigned from allocated PLANET codes 204 and used to track mailpiece 108 through the mailstream. The recipient's physical address is the address to which mailpiece 108 should be delivered. The sender's physical address is a return address in case mailpiece 108 cannot be delivered successfully. Postage indicia can include an indication that the correct amount of postage has been paid. Once sender 102 receives label 402, sender 102 can print label 402 and apply it to mailpiece 108 and place mailpiece 108 in the mailstream.

FIG. 4B depicts an alternative sample mailing label consistent with the present invention. In this alternative, no postage is calculated by E-mail Add-on Service 106, so no postage indicia is included. Once sender 102 receives label 402, sender 102 can print label 402 and apply it to mailpiece 108. In this embodiment, sender 102 will apply the correct postage and then place mailpiece 108 in the mailstream. One skilled in the art would recognize that a variety of variations could be used for the mailing labels consistent with the present invention.

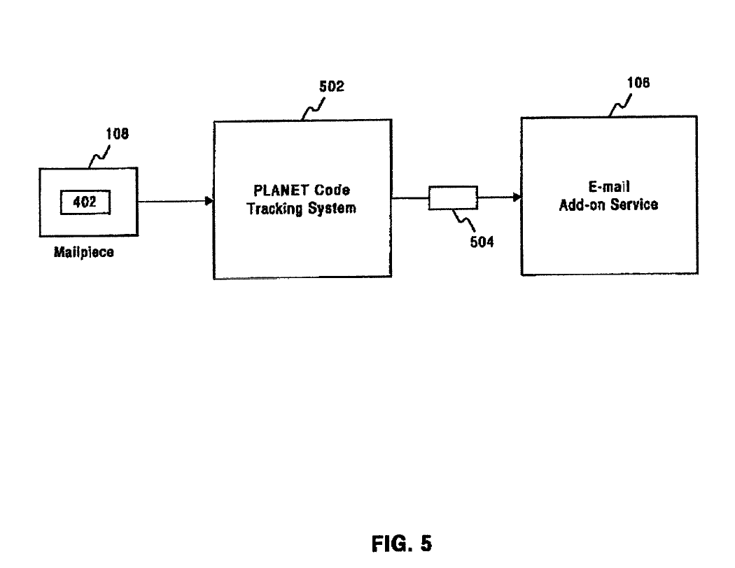

FIG. 5 is a block diagram of a system for tracking mailpiece 108 through the mailstream consistent with the present invention. Mailpiece 108 includes label 402 as described above with reference to FIGS. 4A and 4B. In one implementation, label 402 includes a PLANET code, which is tracked by, for example, bar code sorters and other mail processing equipment. This tracking can be performed by a PLANET code tracking system 502, such as the USPS Confirm system. PLANET code tracking data 504 is sent from PLANET code tracking system 502 to E-mail Add-on Service 106. E-mail Add-on Service 106 utilizes PLANET code tracking data 504 to track mailpiece 108.

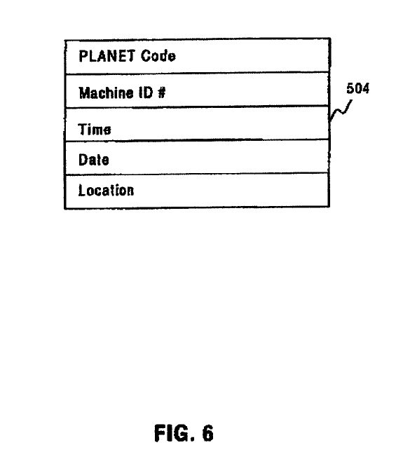

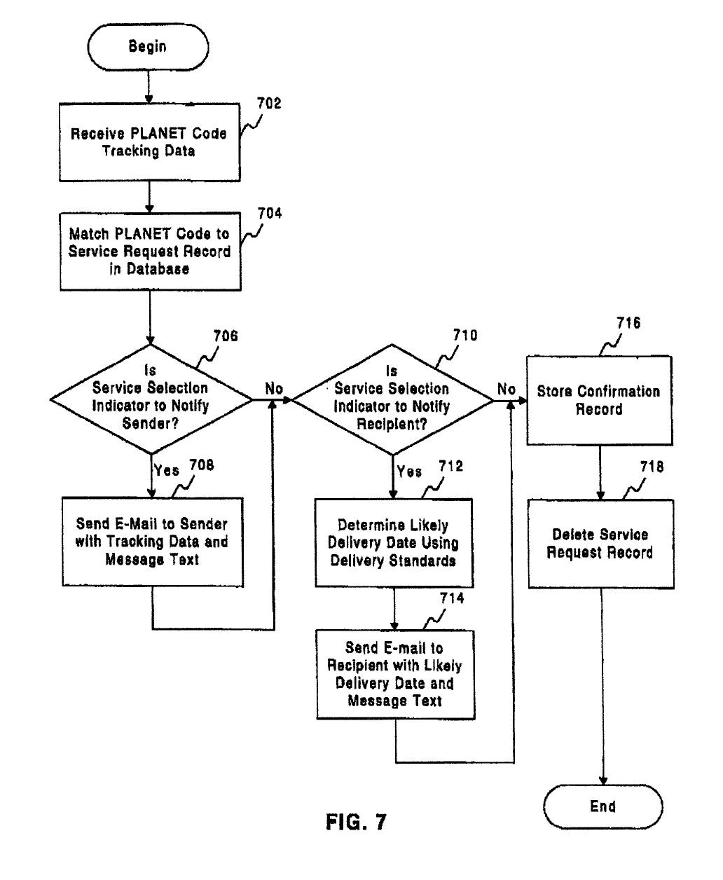

FIG. 6 is an example of one embodiment of PLANET code tracking data. As shown in FIG. 7, PLANET code tracking data 504 can include a PLANET code, a machine identification number (ID #), time, date, and location. The PLANET code can be scanned bar code from label 402 on mailpiece 108. The machine ID # can be identifier of the bar code sorter or other equipment processing mailpiece 108. The time and date represent the time and date the machine processed mailpiece 108, and the location can be the physical location (e.g., Washington, D.C. General Mail Facility) where the machine is located.

As referenced in FIG. 5, E-mail Add-on Service 106 utilizes PLANET code tracking date 504 to track mailpiece 108. As shown in FIG. 3A, moreover, PLANET code tracking data 504 is stored in service request record 302 at E-mail Add-on Service 106. In addition to tracking, E-mail Add-on Service 106 can also use PLANET code tracking 504 for delivery estimates. For example, the originating and destinating delivery standards 206 can make a comparison of addresses to determine an estimated delivery date, which can be sent in an electronic message to the sender and/or the recipient. For example, PLANET code tracking data 504 may indicate that mailpiece 108 bound for San Francisco, Calif. was processed by a bar code sorter in Washington, D.C. on June 1^{st} at 2:00 p.m. Originating and destinating delivery standards 206 might dictate that it takes three days for a mailpiece to travel from Washington, D.C. to San Francisco. Therefore, an electronic message can be sent to the sender and/or recipient indicating the mailpiece 108 should be delivered on June 4^{th}. One skilled in the art would recognize that a variety of other uses could be made with E-mail Add-on Service 106.

FIG. 7 is a flowchart of a process for providing one set of services in an E-mail Add-On Service consistent with the present invention where a PLANET code is used. When PLANET code tracking data 504 is received (702), the PLANET code is matched to a service request record 302 in database 202 (step 704). If the service selection indicator of the service request record 302 is to notify sender (step 706), then an e-mail is sent to the sender with the PLANET code tracking data and the message text from service request record 302 (step 708). If the service selection indicator is to notify the recipient (step 710), originating and destinating delivery standards 206 are applied to the PLANET code tracking data to determine a likely delivery date (step 712). An e-mail is then sent to the recipient with the likely delivery date and the message text from service request record 302 (step 714). Once the e-mail has been sent to the sender and/or the recipient, a confirmation record is stored in database 202 (step 716). One skilled in the art would recognize that a variety of other combinations of services (or even other services) could be made with E-mail Add-on Service 106.

E-mail Add-on Service 106 can support other activities. For example, a sender 102 that has requested and received notification of the delivery of a mailpiece 108 to a recipient 110 (or projected delivery of a mailpiece 108) may take other actions following such delivery and regarding the mailpiece 108. For example, where the mailpiece 108 contains advertising materials, the sender 102 may augment such advertising materials with a telephone follow-up, other marketing events, or the like. A recipient 110 that has requested and received notification of the sending of a mailpiece 108, including perhaps its likely delivery date, can also utilize this information to inform future activities. For example, where the mailpiece contains a payment to recipient, recipient can avoid unnecessarily sending a dunning notice or the like and can otherwise manage cash flow and accounts receivable more effectively. Where the mailpiece is responsive to an advertisement, the recipient can utilize the notification to evaluate the success of an advertising campaign, and on a near real-time basis.

While the invention has been particularly shown and described with reference to preferred embodiments thereof, it will be understood by those skilled in the art that the foregoing and other changes in form and details may be made therein without departing from the spirit and scope of the invention.

I claim:

1. A method for providing delivery information regarding a mailpiece that is being delivered from a sender to a recipient, comprising the steps of:
receiving a service request at a service system from the sender regarding the mailpiece;
receiving an electronic address at the service system from the sender;
storing a tracking code with the service request at the service system;
providing the tracking code by the service system to the sender for marking the mailpiece;
determining tracking data corresponding to the tracking code at the service system, wherein the tracking data indicates a delivery status of the mailpiece; and
sending the tracking data to the electronic address provided by the sender.

2. The method of claim 1, wherein the electronic address corresponds to the sender.

3. The method of claim 1, wherein the electronic address corresponds to the recipient.

4. The method of claim 1, further comprising the step of:
the sender providing a text message to the service system.

5. The method of claim 4, further comprising the step of:
sending the text message to the electronic address with the tracking data.

6. The method of claim 1 wherein the tracking data is a date and time that the mailpiece reaches the recipient.

7. The method of claim 1 wherein the tracking data is an estimated delivery date and time that the mailpiece will reach the recipient.

8. The method of claim 1 wherein the tracking data is a date and time that the mailpiece is sent by the sender.

9. The method of claim 1 further comprising the step of:
the sender contacting the recipient regarding the mailpiece.

10. The method of claim 1 further comprising the step of:
the sender engaging in a marketing event directed to the recipient.

11. The method of claim 8 further comprising the step of:
utilizing the tracking data to evaluate success of an advertising campaign.

12. The method of claim 1 wherein the service system includes a database, a set of allocated codes, originating and destinating delivery standards, and proper address formatting software.

13. The method of claim 12 wherein the service system further includes a postage processor.

14. The method of claim 1 further comprising the steps of:
the service system generating a printable label for the mailpiece; and
sending the printable label to the sender.

15. The method of claim 14 wherein the printable label includes the tracking code, the recipient's physical address, and the sender's physical address.

16. The method of claim 15 wherein the printable label further includes postage indicia.

17. The method of claim 5 further comprising the step of:
creating a confirmation record.

18. The method of claim 17 wherein the confirmation record includes a date and time that service was provided, type of service provided, and content of the text message.

19. A method for providing delivery information regarding a mailpiece that is being delivered from a sender to a recipient, comprising the steps of:
receiving a service request at a service system from the sender regarding the mailpiece;
wherein the service system includes a database, a set of allocated codes, originating and destinating delivery standards, and proper address formatting software;
receiving an electronic address at the service system from the sender;
storing a tracking code with the service request at the service system;
providing the tracking code by the service system to the sender for marking the mailpiece;
the service system generating a printable label for the mailpiece;
wherein the printable label includes the tracking code, the recipient's physical address, and the sender's physical address;
sending the printable label to the sender;
determining tracking data corresponding to the tracking code at the service system, wherein the tracking data indicates a delivery status of the mailpiece; and
sending the tracking data to the electronic address provided by the sender.

20. A delivery information system for mailpieces comprising, in combination:
a service system;
a mailpiece;
a database adapted to store records for requests for service from the service system relating to delivery of the mailpiece and records of confirmation of the service;
allocated codes to track the mailpiece through a mailstream;
an electronic address for one of a sender and a recipient of the mailpiece; and
a network permitting the sending of an electronic message regarding delivery status of the mailpiece from the service system to the electronic address.
